(19) United States
(12) Patent Application Publication
(10) Pub. No.: US 2019/0387092 A1
(43) Pub. Date: Dec. 19, 2019

(54) Cellular Telephone Battery Power Augmentation Accessory with Satellite Backup Communication Link

(71) Applicant: Thomas Ronald Tessier, Winnipeg (CA)

(72) Inventor: Thomas Ronald Tessier, Winnipeg (CA)

(21) Appl. No.: 16/008,557

(22) Filed: Jun. 14, 2018

(51) Int. Cl. H04M 1/725; H04B 1/3883

(52) U.S. Cl. CPC H04M 1/72527; H04W 88/06; H04B 1/3883

(57) ABSTRACT

A portable telephone apparatus includes an external separate assembly acting as a power storage device with charger circuit and as a satellite transmitter/receiver unit for text communications in the event that the cell signal for the telephone is not available. An app uses the processing capabilities of the cellular telephone to create communication data where many functions of the satellite transmitter/receiver of the external assembly are controlled by the cellular telephone app to reduce the functions in the external device to receiving and transmitting capability and a controller to queue data and control transmission and reception. The the external assembly operates both the functions of a satellite transmitter/receiver unit and the power storage device simultaneously and independently of one another without requirement for switching.

This application relates to a cellular telephone battery power augmentation accessory which includes a satellite backup communication link.

### BACKGROUND OF THE INVENTION

The popularity of “smart” cellular telephones with high power requirements means users are often frustrated with loss of service due to depletion of battery power within their cellular telephone. Likewise, with only 10% of the Earth's surface serviced by cellular telephone systems, travelling users are often frustrated with the loss of communication capability.

Finally, there are dual-mode cellular/satellite devices available today but they are characterized as having extra functions for users to learn, often being quite complicated for users to use on an occasional basis.

The invention described herein provides extra battery power to cellular telephone users to maintain additional cellular telephone user time and a backup satellite link to allow continuation of communication services in a very simple, automated fashion when cellular communication services are not available.

### SUMMARY OF THE INVENTION

According to the invention there is provided a portable telephone apparatus comprising:

a cellular telephone component comprising a processor providing processing capabilities and geographic positioning capabilities, a camera, a keypad, wireless accessory connections, a speaker, a microphone and a cellular telephone system;

the cellular telephone component including an operating system capable of running a customized software program (“app”);

and an external assembly separate from the cellular telephone component comprising:
a power storage device with charger circuit, to provide a function of a backup battery to the cellular telephone component through a connecting cable that can charge the cellular telephone component and power internal circuits of the cellular telephone component;
a satellite transmitter/receiver unit with an antenna;
and wired and/or wireless link to the cellular telephone component;

where the app uses the processing capabilities of the cellular telephone component to create communication data and/or audio signals for transmission and presenting of received data to the user as audio streams or data messages;

where many functions of the satellite transmitter/receiver of the external assembly are controlled by the cellular telephone app, so that only a minimum number of functions are embodied in the external assembly including receiving capability, transmitting capability, and a controller to queue data and control transmission and reception,

where the app automatically chooses whether to use either the cellular telephone system of the cellular telephone component or the external satellite communication link;

and where the external assembly conducts the functions of both the satellite transmitter/receiver unit the power storage device for the cellular telephone component simultaneously and independently of one another.

Preferably the app uses the processing capabilities of the cellular telephone component to inform the cellular telephone user if the cellular network is available and if the satellite network is available.

Preferably the controller of the external assembly is arranged to archive data and audio to be transmitted in the future over a satellite connection if the satellite cannot be contacted at that moment.

Preferably the app uses the processing capabilities of the cellular telephone component to advise the cellular telephone user if the satellite network is available for transmission.

Preferably the app uses the processing capabilities of the cellular telephone component to estimate on how much time it will be until the satellite network is available for transmission, in the event that the communication link uses at least one Low Earth Orbit (LEO) satellite or LEO constellation such as Globalstar or Iridium.

Preferably the external assembly uses a wireless link such as Bluetooth, Zigbee or WiFi for 2-way communication link to the cellular telephone component.

Preferably the app uses the processing capabilities of the cellular telephone component to connect to the external assembly whenever the external assembly is powered on and either connected directly by cable, such as a USB connection, or wirelessly, such as by Bluetooth, without any intervention by the user of the cellular telephone component.

Preferably the app uses the processing capabilities of the cellular telephone component to appear as a “text messaging” app that selects to send and receive text messages through the terrestrial cellular telephone network or through the external assembly automatically without input from the user.

Preferably the app uses the processing capabilities of the cellular telephone component to allow the user to set preferences to use the cellular connection or satellite connection only, or to default to either the satellite or cellular connection as a first priority and use the other system when needed.

Preferably a switch is provided in the external assembly which, when actuated, sends a distress signal over the satellite system.

The ability to conduct complex operations in an automated way in a program running on a cellular telephone operating system means major functions that could only be operated in hardware can now be conducted on a cellular telephone. This significantly lowers the cost and complexity of hardware needed for satellite transmissions to be conducted.

### BRIEF DESCRIPTION OF THE DRAWINGS

FIG. 1 is a schematic layout of the apparatus according to the present invention.

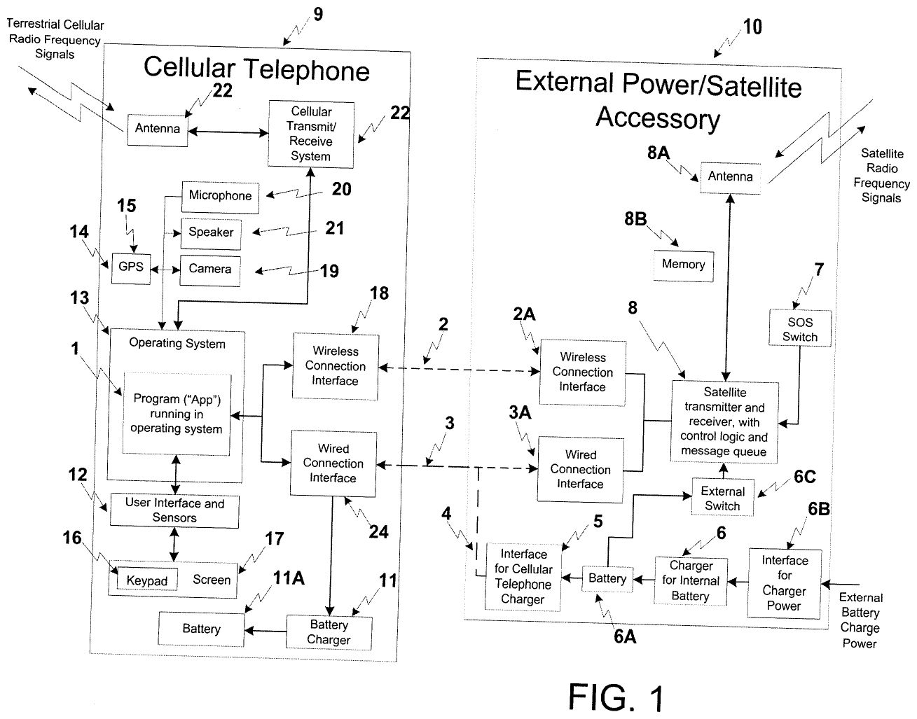

### DETAILED DESCRIPTION

The apparatus comprises a conventional cellular telephone component 9 and an external connectable component 10.

The cellular telephone component comprises a processor 13 providing processing capabilities and geographic positioning capabilities 15, a camera 19, a keypad 16 on a screen 17, wireless accessory connections 18 communicating by a link 2, a speaker 20, a microphone 21 and a cellular telephone system 22 including an antenna 23, a wired connection interface 24 communicating by a link 3, and a battery charger 11 of a battery 11A.

The external assembly 10 is separate from the cellular telephone component and includes a power storage device 6A with charger circuit 6 and interface 6B, to provide a function of a backup battery to the cellular telephone component through a connecting cable 4 and interface 5 that can charge the cellular telephone component and power internal circuits of the cellular telephone component.

The assembly 10 further includes a satellite transmitter/receiver unit 8 with an antenna 8A together with a wireless interface 2A and a wired interface 3A. In this way the assembly 10 can provide either a wired and/or wireless link to the cellular telephone component.

Control of the system is exerted in the program running on an operating system or “app” 1 on the processor 13.

The wireless connection 2 or a wired connection 3 carries control and communication traffic between the Cellular Telephone 9 and the External Power/Satellite Accessory 10. The connecting lines 2 and 3 are dashed to indicate that either one of them can be active at one time.

If a wired connection 3 is used, then power for charging the cellular telephone 4 is provided by the interface for cellular telephone charging 5 to the cellular telephone for charging its internal battery and/or operating its electronics, according to the functions of the cellular telephone battery charger 11.

When the app 1 is connected to the satellite transmitter and receiver system 8 in the external power/satellite accessory 10, control signals from the app 1 control the actions of control logic 8 and satellite data and/or voice messages are exchanged between processor 1 and control logic 8.

The operation of the battery charging system 11, 4, 5 and 6, operate independently of the satellite communication link in control logic 8.

The app 1 takes full advantage of functions built-in to the cellular telephone, with interfaces internally to the cellular telephone user interfaces and sensors 12, thus eliminating the need for the external power/satellite accessory 10 to have these capabilities, thus lowering cost and complexity for the user.

The processor 13 using the app 1 automatically chooses whether to use either the cellular telephone system, typically if this is available for use as the lower cost option of the cellular telephone component or to use the external satellite communication link if the cell signal is not available. This is done automatically by the program and does not require input from the user, although the criteria for selection may be initially input by the user.

The app uses the processing capabilities 13 of the cellular telephone component 9 to inform the cellular telephone user using the display 17 if the cellular network is available and if the satellite network is available. These are typically displayed as icons on the screen using conventional display.

The controller 8 of the external assembly 10 is arranged to archive in a memory 8A data and audio to be transmitted in the future over a satellite connection if the satellite cannot be contacted at that moment. That is the control logic 8 has sufficient processing power to schedule the transmissions.

The app 1 uses the processing capabilities 13 of the cellular telephone component to advise the cellular telephone user through the display 17 if the satellite network is available for transmission.

The app 1 uses the processing capabilities 13 of the cellular telephone component to estimate on how much time it will be until the satellite network is available for transmission, in the event that the communication link uses at least one Low Earth Orbit (LEO) satellite or LEO constellation such as Globalstar or Iridium and again to display this to the user. This allows the user to monitor when signals have been transmitted.

The app 1 uses the processing capabilities 13 of the cellular telephone component to connect to the external assembly whenever the external assembly is powered on by an external switch 6C and either connected directly by cable 3, such as a USB connection, or wirelessly, such as by Bluetooth 2, without any intervention by the user.

The app acts to appear as a “text messaging” app that will send and receive text messages through the terrestrial cellular telephone network or through the external assembly automatically without input from the user. That is the system carries out the functions of selecting which medium to use and to transmits the signals using the selected medium all without input or even display to the user. In this way the user appears to send texts in the usual manner in the confidence that the texts will be transmitted in the event that the cell signal is not available. The system uses the lower cost cell system in all cases when available and typically only changes to the satellite communication where the program determines that no cell signal is available.

However the app can be operated to allow the user to set preferences to use the cellular connection or satellite connection only, or to default to either the satellite or cellular connection as a first priority and use the other system when needed using the screen and keyboard 16, 17 of the interface 12.

The app can program a switch of the input 16, 17 or can provide a mechanical external switch 7 on the external assembly 10 which, when actuated, sends a distress signal over the satellite system by activating the logic 8.

1. A portable telephone apparatus comprising:
a cellular telephone component comprising a processor providing processing capabilities and geographic positioning capabilities, a camera, a keypad, wireless accessory connections, a speaker, a microphone and a cellular telephone system for communication with a cellular telephone network;
the cellular telephone component including an operating system capable of running a cellular telephone app;
and an external assembly separate from the cellular telephone component comprising:
a power storage device with charger circuit, to provide a function of a backup battery to the cellular telephone component through a connecting cable that can charge the cellular telephone component and power internal circuits of the cellular telephone component;
a satellite transmitter/receiver unit with an antenna for communication with a satellite communication network using Low Earth Orbit (LEO) satellites;
and wired and/or wireless link to the cellular telephone component;
where the app uses the processing capabilities of the cellular telephone component to create communication data and/or audio signals for transmission and presenting of received data to a cellular telephone user as audio streams or data messages;
where many functions of the satellite transmitter/receiver of the external assembly are controlled by the cellular telephone app, so that only a minimum number of functions are embodied in the external assembly including receiving capability, transmitting capability, and a controller to queue data and control transmission and reception,
where the app automatically chooses whether to use either the cellular telephone system of the cellular telephone component or the external satellite communication network;
and where the external assembly conducts, using power from the power storage device, both the function of the satellite transmitter/receiver unit and the function of the backup battery to the cellular telephone component both simultaneously and independently of one another.

2. The apparatus according to claim 1 wherein where the app uses the processing capabilities of the cellular telephone component to inform the cellular telephone user if the cellular telephone network is available and if the satellite communication network is available.

3. The apparatus according to claim 1 wherein the controller of the external assembly is arranged to archive data and audio to be transmitted in the future over a satellite communication network if the satellite communication network cannot be contacted at that moment.

4. The apparatus according to claim 1 wherein the app uses the processing capabilities of the cellular telephone component to advise the cellular telephone user if the satellite communication network is available for transmission.

5. The apparatus according to claim 1 where the app uses the processing capabilities of the cellular telephone component to estimate on how much time it will be until the satellite communication network is available for transmission.

6. The apparatus according to claim 1 wherein the external assembly uses a wireless link for 2-way communication link to the cellular telephone component.

7. The apparatus according to claim 1 wherein the app uses the processing capabilities of the cellular telephone component to connect to the external assembly whenever the external assembly is powered on and either connected directly by cable or wirelessly without any intervention by the cellular telephone user.

8. The apparatus according to claim 1 wherein the app uses the processing capabilities of the cellular telephone component to appear as a “text messaging” app that sends and receive text messages through the cellular telephone network or through the external assembly automatically without input from the cellular telephone user.

9. The apparatus according to claim 1 where the app uses the processing capabilities of the cellular telephone component to allow the cellular telephone user to set preferences to use the cellular telephone network or the satellite communication network only, or to default to one of the satellite communication network and cellular telephone network as a first priority and use the other of the satellite communication network and cellular telephone network when needed.

10. The apparatus according to claim 1 wherein a switch is provided in the external assembly which, when actuated, sends a distress signal over the satellite communication network.
